(19) United States
(12) Patent Application Publication
(10) Pub. No.: US 2007/0243029 A1
(43) Pub. Date: Oct. 18, 2007

(54) Continuous shearing edges made of brazed carbide grits for use on a tool

(76) Inventor: Lloyd R. Oliver, Algonac, MI (US)

Correspondence Address: Michael T. Raggio;Raggio & Dinnin, P.C., Ste. 410, 2701 Cambridge Court, Auburn Hills, MI, 48326, US

(21) Appl. No.: 11/403,797

(22) Filed: Apr. 13, 2006

(51) Int. Cl. B23D 71/00

(52) U.S. Cl. 407/29.1

(57) ABSTRACT

A preformed continuous or interrupted shearing machining edges that are composed of hard substance grits and are brazed together and to steel grinding wheels or other tool members. The parallel edges may be interrupted by voids between teeth of the edges. The edges have selectable edge rakes and clearance angles, edge tooth widths, edge spacing and mounting angles to the tool members or grinding wheel work surfaces.

### BACKGROUND OF THE INVENTION

1. Field of the Invention

The present invention generally relates to abrasive grit structures used in the grinding and shaping of various material, and more particularly, relates to a continuous circular shearing edge composed of brazed carbide grits for use on a cutting and/or grinding tool for non metal materials and compositions.

2. Description of Related Art

Abrasive grit tool structures have been known for numerous years. Generally, the abrasive grit tool structures include devices such as grinding wheels, hand tools, and the like which generally have an outer grit particle surface which is used to remove portions of a work piece for shaping and finishing a work piece. In many prior art structures, abrasive grits have been attached to tool surfaces by placing a single layer of grit particles on a tool form and then binding the grits to the tool by using a brazing metal or by an electro plating coating which grips the grit particles. These structures along with other types of structures have the disadvantage of that the resulting tool may have grits of widely varying heights, erratic grit edges, flat spots or other irregular surfaces which tend to present an uneven grinding surface with relation to the work piece. It should be noted that in grinding structures the desired effect is to present the abrasive grits to the work piece at a uniform level in order to most effectively shape the work piece. Many of these prior art grinding wheels and the like fail to meet this objective.

Many prior art grinding wheels are generally made from electroplating or brazing of materials onto the outer surface of the structures. Other prior art grinding wheel structures have been produced by either pressure forming a grinding wheel on a mold or grinding surfaces that have been added to tools by placing an individual tool on the mold and using pressure molding and brazing procedures to attach the grinding surface to a substrate mold surface. However, many of these prior art procedures are costly, time consuming, and require special equipment that is hard to manufacture and maintain.

Furthermore, many of the prior art grinding wheel structures generally do not provide adequate space between the grinding particles. This results in diminished use for the lifetime of the tool due to particles of the work piece being lodged between the grit particles or extending over the grit particles such that contact between the individual grit particles and the work piece is reduced thereby inhibiting the grinding action and efficiency of the wheel.

In the prior art nearly all rubber and other elastomers have only been mechanically worked by various rasp shredding and abrading tools. Many of these prior art tools tend to be very inefficient as compared to the present invention. Many of these prior art devices waste much of the power input to friction caused heat, smoke, reverted material, and abraded surfaces. Some prior art grinding tools have the cutting edge widths run substantially parallel to the axis of rotation. Furthermore, other prior art devices have minimal and insufficient edge rakes and clearances such that whenever these tools are used on elastomers the edges cause excessive deformation into and friction from contact with the work pieces which have relatively great elastic recovery that rubs on the edge rake faces and edge clearances. The results of many of these prior art wheels is not satisfactory work pieces such as covered rollers.

Therefore, there is a need in the art for an improved grinding wheel or tool that includes a plurality of continuous parallel edges arranged at a predetermined angle on the tool work face. These edges will be capable of grinding non-metallic materials in a cost effective long term package. There also is a need in the art for a grinding wheel that will perform more efficiently and reduce the amount of friction encountered during the grinding of many non-metal materials. Furthermore, there is a need in the art for a grinding wheel or tool that has increased positive edge rakes and clearances and the use of more effective edge shearing angles for enhanced mechanical removal efficiency of the material being ground by the grinding wheel.

### SUMMARY OF THE INVENTION

One object of the present invention is to provide an improved grinding wheel for use in grinding down non-metal materials.

Another object of the present invention is to provide an improved edge design to be molded with various hard grit materials.

Yet a further object of the present invention is to provide a grinding tool having a plurality of parallel edges that are oriented in a predetermined direction on the tool face.

Still a further object of the present invention is to provide a grinding wheel with a plurality of parallel edges that have increased cutting clearance, positive cutting edge rakes, edge clearance angles and edge shearing angles to the axis of rotation of the tool.

Still another object of the present invention is to provide a grinding wheel that substantially reduces the inherent friction and deformation of the materials being worked.

Still another object of the present invention is to provide a plurality of parallel edges on a tool that may have interrupted continuous edges defined by voids along a common edge line.

Still another object of the present invention is to provide a grinding tool for use in grinding non-metal materials at a lower cost with reduced maintenance.

Still another object of the present invention is to provide a grinding wheel that will operate with less friction while also increasing the durability of a grinding wheel.

To achieve the foregoing objects, a tool for grinding non-metal materials is disclosed. The tool includes a plurality of molded parallel edges. The edges are brazed to a working face of the tool with an alloy. The edges have a predetermined rake angle and edge clearance and also extend a predetermined height from the tool.

One advantage of the present invention is that it provides an improved edge cutting structure for a grinding tool.

Still another advantage of the present invention is that it provides an improved grinding wheel for use in grinding down metal materials.

Still another advantage of the present invention is that the parallel edges provide a more efficient grinding wheel.

Still another advantage of the present invention is that the continuous edges provide less friction caused heat during the grinding of non-metal materials.

Yet a further advantage of the present invention is that the edges are parallel and continuous or interrupted with predetermined voids therein.

Still another advantage of the present invention is that the use of numerous parallel edges allows for the ability to space the edges at predetermined intervals which allows controlled removal rate and surface finish from the revolving wheel face.

Another advantage of the present invention is the use of interrupted continuous edges by the use of predetermined width voids which will serve to increase removal efficiency and to obtain various desired surface finish smoothness or roughen conditions on the worked surfaces.

Other objects, features and advantages of the present invention will become apparent from the subsequent description and the appended claims, taken in conjunction with the accompanying drawings.

### BRIEF DESCRIPTION OF THE DRAWINGS

FIG. 1 shows a cross section end view of a continuous interrupted edge according to the present invention.

FIG. 2 shows a close up cross sectional view of a continuous edge according to the present invention.

FIG. 3 shows a top view of the parallel continuous edges according to the present invention.

FIG. 4 shows a close up top view of the parallel continuous edges according to the present invention.

FIG. 5 shows a side view of the edges having a void in the continuous edge.

FIG. 6 shows a close up view of the side view of the edges according to the present invention.

FIG. 7 shows a mounting angle of the edges on the face of a tool according to the present invention.

FIG. 8 shows a close up view of the mounting shearing angle of the edges on the face of a tool.

### DESCRIPTION OF THE EMBODIMENT(S)

Referring to the drawings, the present invention of continuous shearing edges 10 composed of brazed carbide grits for use on a tool or grinding wheel 12 are shown. It should be noted that the continuous edges 10 are selectively attachable to a tool surface or a tool 12 such as a grinding wheel or the like. Applicant has developed various methods and apparatuses for connecting or molding teeth like structures to tool or surfaces and the present invention can be used with any of the Applicant's previous inventions and therefore, the Applicant hereby incorporates by reference prior U.S. Pat. Nos. RE 35,182; 4,916,869 and 6,821,196.

The edge structures 10 according to the present invention comprise pre-formed continuous or interrupted shearing machining edges that are composed of hard substance grits that are brazed together onto steel wheels or other tool or base members. The edges 10 may be interrupted by voids 14 between teeth 16 of the edges 10. The edges 10 have hard substance grits arranged therein and these grits may include various metal carbides, borides, nitrides, and diamond and other like hard materials. The shearing edge structures 10 of the present invention are preformed and may be continuous or interrupted by voids 14 to make edge teeth 16. The edges 10 may be made parallel to one another and can also be positioned to selective shearing angles. The preformed edges are molded from the processes and methods described in the previous U.S. patents of the Applicant incorporated by reference above. After the preformed edges 10 are created, they are positioned on a steel tool base or grinding wheel 12. A hard filler material such as a metal is used to infiltrate and braze the grits to their preformed edge constructions and to the base of the tools 12 that are heated in a controlled atmosphere furnace. Many of the prior art magnetic and molded mechanical teeth are very effective abrading tools for use on all elastomers and other non-metals, however they do not perform with the efficiency of the machining edge structures 10 of the present invention. The present invention enables the selection of increased positive edge rakes and clearances while also the use of edge shearing angles for enhanced mechanical removal efficiency. The elastic recovery of the elastomers is substantially reduced by the gradual and efficient penetration into the work piece of the edges 10 while the edges 10 also shear away cuttings transversely.

The most efficient machining of soft durometer, coverings or non-metals, such as rubber covered rollers, require that the edge rake and clearance angle along with the shearing angle be substantially increased. The increased deformation recovery of these materials make it necessary to increase the selectable positive cutting edge rakes, the edge clearance angles and the edge shearing angles to the axis of rotation of the tool. Increasing one or more of these angles is necessary to eliminate or substantially reduce the inherent friction and deformation of these materials that are easily deformed.

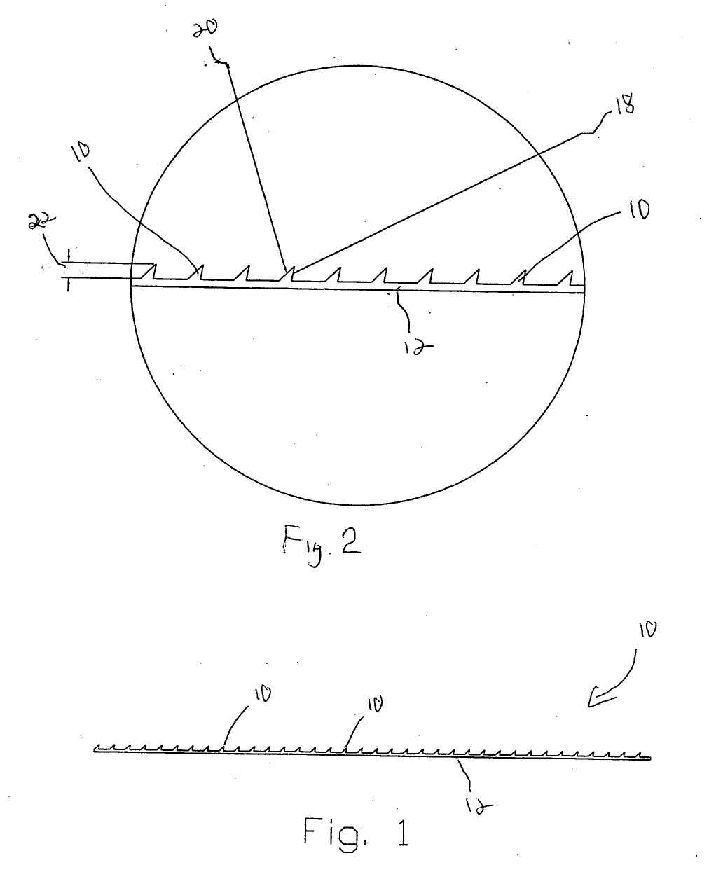

FIGS. 1 through 4 show the edges 10 for use on a grinding tool 12 according to the present invention. The edges 10 generally extend in a continuous linear direction for the width of the tool 12 working face. However, the edges 10 may only extend a predetermined distance across the tool 12 less than the full width. The edges 10 have a generally triangular or half pyramidal cross sectional shape as shown in FIGS. 1 and 2. However, any other known shape may also be used. The edges 10 generally have a positive rake angle 18. However, it should be noted that it is contemplated to use a neutral or negative rake angle for the edges 10 as disclosed in this invention. The positive rake angle 18 may be changed to any of a preferred number of angles depending on the material being ground and the angle at which the edges 10 will be placed on the tool 12 work face. Generally, the positive rake angle 18 is approximately in the range of neutral/zero degrees to 90 degrees for the present invention. The edges 10 also include a predetermined edge clearance angle 20 which is selectable or adjustable depending on the material being ground and the angle at which the edges 10 are placed on the tool 12 face. Generally, the edge clearance angle 20 is approximately within the range of five degrees and 90 degrees. This will determine how much of the backside of the cutting edges 10 contact the non-metal material being ground. Another adjustable feature of the edges 10 is the height 22 of the edges 10 that extends from the tool or grinding wheel 12. The height 22 will determine the depth of cut of the cutting edges 10 into the non-metal material being ground or worked. The height 22 of the edges 10 may be anywhere from a few hundredths to multiple inches depending on the size of the grinding wheel or tool 10 and the device being ground.

As shown in FIGS. 1 and 2 the cutting edges 10 are generally arranged in a parallel direction with relation to one another on the working face of the tool or grinding wheel 12. It should be noted that a single linear edge 10 may be used on a tool 12, but in the one contemplated embodiment shown a plurality of edges 10 is used in which the edges 10 are parallel to one another on the surface of the tool 12 work face.

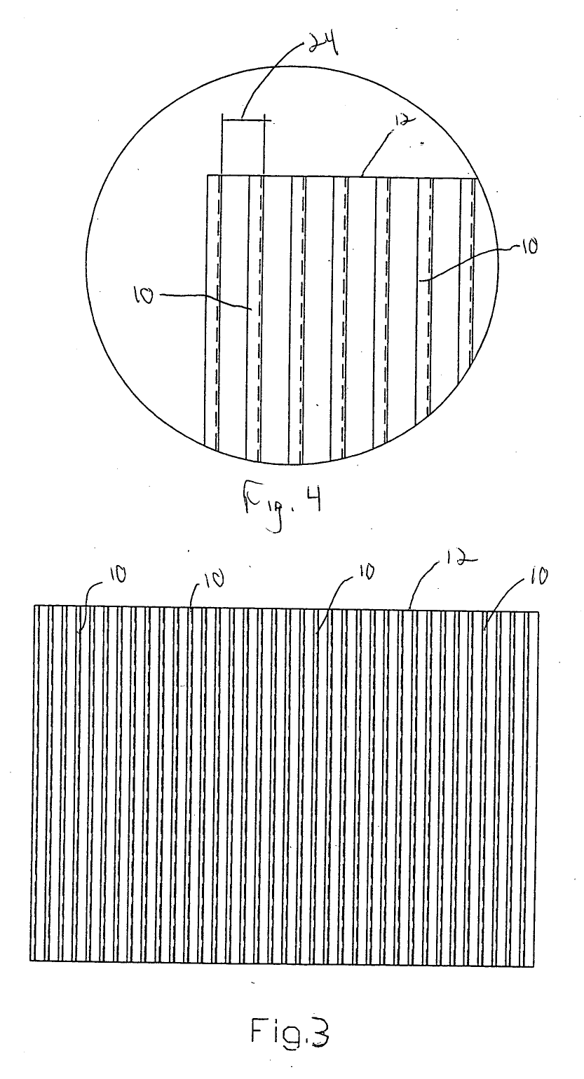

FIGS. 1 through 4 show the continuous parallel edges 10 as it would be arranged in one contemplated embodiment on the work face of a tool or grinding wheel 12. FIGS. 3 and 4 show a top view of the present invention in which a predetermined distance or spacing 24 occurs between adjacent parallel edges 10. The distance 24 between the parallel edges 10 is generally within the approximate range of a sixteenth of an inch to five inches depending on the size of the grinding wheel 12 and the material being ground by such wheel or tool 12. FIGS. 3 and 4 show the parallel continuous edges 10 arranged on the work face of a tool 12 according to the present invention. As shown in FIGS. 1 through 4, the edges 10 have the pre-selected features such as predetermined edge rake angle 18, clearance angle 20, height of the edges 22 and spacing between the parallel adjacent edges 24 preformed and molded in any of the Applicant's previously described processes in the patents incorporated by reference above. After the edges 10 are composed and formed from hard substance grits they are subsequently applied to and secured to the face of the tool 12 by a brazing alloy. The ability to change on select various edge features enables the use of the most suitable and efficient design of the edges 10 for specific applications to work a variety of work pieces having variable characteristics of any of the known non-metal materials and the machineability of the material to be mechanically worked. Generally, the preformed edges are adhered to an adhesive transfer tape, which is well known in the art, for subsequent placement on and brazing to a base of a tool or grinding wheel 12.

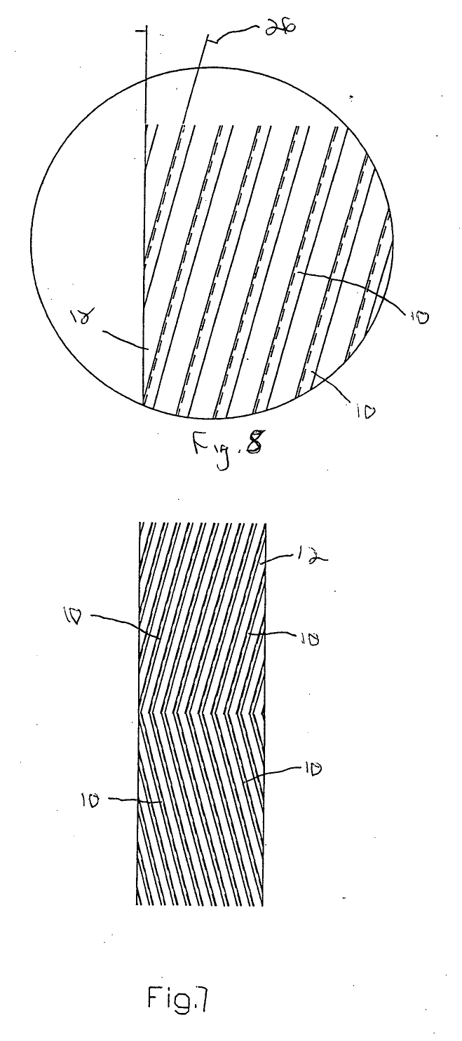

These preformed edges 10, which are arranged on transfer tapes, allow for the edges 10 to be mounted at any of a predetermined selected shearing angle 26 to the axis of rotation of the tool 12. The shearing or mounting angle 26 generally is within the approximate range of zero degrees to 90 degrees to the axis of rotation of the tool 12. FIG. 7 shows one contemplated mounting of the parallel cutting edges 10 of the present invention at a predetermined shearing or mounting angle 26 to that of the face of the tool or grinding wheel 12. The use of predetermined shearing angles 26 allow for the shearing edges of the present invention to gradually and more efficiently penetrate into their depth of cutting as they shear off cuttings transverse to their axis of rotation with greatly reduced deformation recovery. The ability to space the continuous parallel edges 10 apart at a predetermined distance 24 allows for control of the removal rate and surface finish from the revolving wheel face. Thus, the shearing or mounting angle 26 of the parallel edges 10 will be determinant upon the type of non-metal being ground and the durometer hardness of that material.

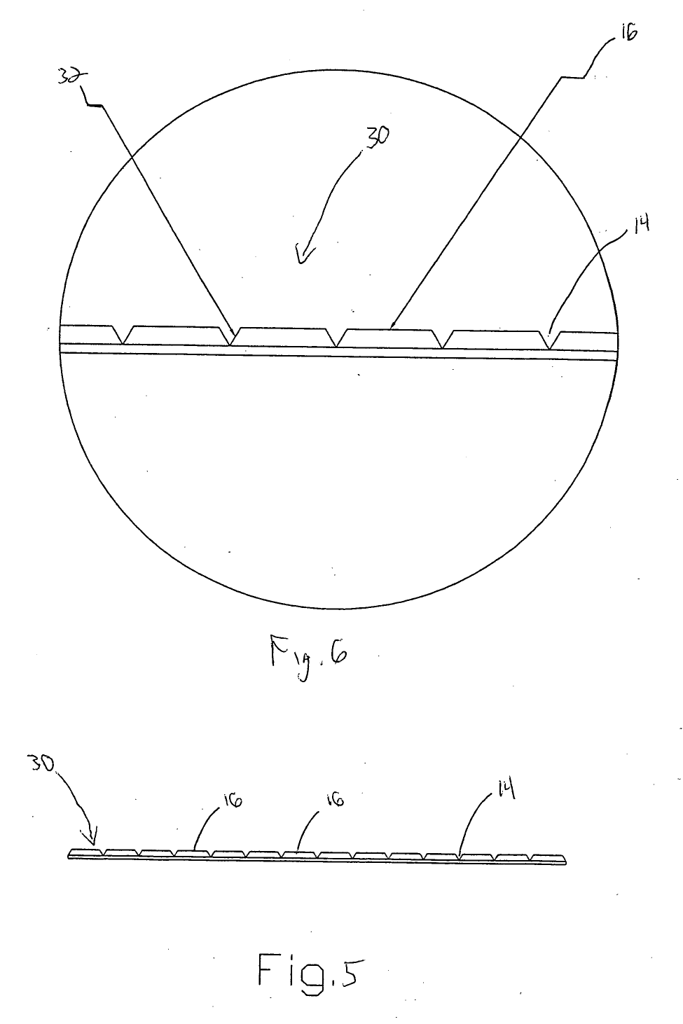

FIGS. 5 and 6 show an alternate embodiment of the edges 30 for use in the present invention. The edges 30 are interrupted by voids or gaps 14 to result in selected tooth edge width and void 14 widths to a common shearing edge line. This interrupted continuous edge 30 will increase removal efficiency and obtain various desired surface smoothness or roughened conditions depending on the material being ground. The interrupted edges 30 establish both a width of the edge teeth 16 and the width of the voids 14 therebetween. Each tooth 16 has a predetermined angle 32 at each end of each edge tooth 16. The angle 32 is defined by the voids 14 on the continuous interrupted edges 30. Each of the angles 32 is arranged on the preformed edges. The relief angle 32 at the ends of the edge teeth 16 enables easy removal of the edges 30 from the grit molds. The relief angle 32 is generally within the approximate range of zero to 90 degrees depending on the material being ground and the durometer of hardness of such material. Therefore, the interrupted edges 30 are generally placed on the tool face 12 in a parallel manner with respect to adjacent interrupted edges 30. The edges 30 also may be placed on the tool face at a predetermined shearing or mounting angle 26 as described above. It is also contemplated to use the interrupted edges 30 in the form of a single interrupted edge however in the preferred contemplated embodiment a plurality of parallel interrupted edges 30 are arranged on a tool face at a predetermined shearing angle 26. As described above the brazed and grit particles used in the present invention may be of any kind of metal carbide, boride grits, or grits which are harder than metal carbides and up to and including diamond like hardness. For instance, various cast or sintered metal carbide grits may be suitably used in the present invention while it should also be noted that harder grits such as cubic boron nitrate, polycrystalline diamond, or natural diamond grits can also be used in the present invention. The setting material consists of a material which provides adequate strength for holding the particle on the structure such as by chemically bonding with the brazing material. In one embodiment of the invention where a diamond or hard like particle is used, the setting material is a fine metal carbide powder. The design of the edges is such that it is molded of various particles sizes by a molding means as used to form the non-metal melting particles for a predetermined size and shape while also allowing the molded edges 10 to be removed and transferred to a pre machined metal body for use as a cutting edge on a grinding wheel 12. These preformed edges 10 are subsequently infiltrated and brazed to the body of the grinding wheel 10 by use of a filler material which has a lower melting temperature then the particles which are molded in the edges 10 and the tool body 10 to be armored. Any other known method of brazing or attaching teeth or parallel edges to a tool body 10 may also be used however the preferred methodology are those disclosed in the previous patents of the Applicant. The use of these continuous circular shearing edges 10 composed of brazed carbide grits will allow for a more efficient removal and longer tool life in removing any specific and all durometer hardness material, uncovered rollers, or other work pieces to be machined.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

1. A tool for use in mechanical working of non-metals, said tool comprising;
a plurality of linear parallel cutting edges arranged on the tool; and
said edges mounted on the tool at a predetermined angle to the tool working face, said edges having a predetermined positive rake angle.

2. The tool of claim 1 wherein said edges are continuous across the working face of the tool.

3. The tool of claim 1 wherein said edges having hard substance grits therein.

4. The tool of claim 1 wherein said edges are attached to the tool with a brazing alloy.

5. The tool of claim 1 wherein said predetermined positive rake angle is in a range of approximately zero to ninety degrees.

6. The tool of claim 1 wherein said angle having a predetermined clearance angle in a range of approximately five to ninety degrees.

7. The tool of claim 1 wherein said edges having a predetermined height from the tool.

8. The tool of claim 1 wherein adjacent said parallel edges having a predetermined distance there en.

9. The tool of claim 1 wherein said edges having predetermined spaced voids therein.

10. The tool of claim 9 wherein said edges having a predetermined width to create a tooth like structure.

11. The tool of claim 10 wherein said teeth having a predetermined angle on each end thereof.

12. The tool of claim 1 wherein said edges are molded before being arranged on the tool.

13. A tool for grinding non-metal materials, said tool comprising:
a plurality of molded linear parallel edges, said edges brazed to a working face of the tool with an alloy;
said edges having a predetermined positive rake angle and a predetermined edge clearance angle; and
said edges extending a predetermined height from the tool.

14. The tool of claim 13 wherein said edges are continuous.

15. The tool of claim 13 wherein said edges are interrupted with a plurality of voids having a predetermined width.

16. The tool of claim 13 wherein adjacent said edges having a predetermined distance therebetween.

17. The tool of claim 13 wherein said edges having a predetermined mounting angle with respect to said working face of the tool.

18. The tool of claim 13 wherein said edges having hard substance grits therein.

19. The tool of claim 15 wherein said interrupted edges form teeth defined by said voids, said teeth having a predetermined angle on each end thereof

20. A method of making a grinding tool or wheel for non-metals, said method including the steps of:
performing selected parameters of continuous or interrupted linear parallel edges;
molding said parallel edges;
adhering said parallel edges to transfer medium; and
attaching said parallel edges to said tool by brazing at a predetermined shearing angle.
